(19) United States
(12) Patent Application Publication
(10) Pub. No.: US 2019/0315061 A1
(43) Pub. Date: Oct. 17, 2019

(54) SHAPING APPARATUS AND METHOD OF MANUFACTURING SHAPING APPARATUS

(71) Applicant: KANTATSU CO., LTD., Yaita-shi (JP)

(72) Inventors: Eiji OSHIMA, Tochigi (JP); Tomohiro OKATA, Tochigi (JP)

(21) Appl. No.: 16/375,749

(22) Filed: Apr. 4, 2019

(30) Foreign Application Priority Data
Apr. 12, 2018 (JP) 2018-077043

(51) Int. Cl. B29C 64/25; B33Y 30/00

(52) U.S. Cl. CPC B29C 64/25; B33Y 30/00

(57) ABSTRACT

This invention enables to avoid an overall apparatus from becoming large. There is provided a shaping apparatus including a shaping unit that forms a shaped object and a case that stores the shaping unit, the case including a fixed panel having a curved surface and a moving panel having a curved surface, wherein the fixed panel and the moving panel are engaged with each other via a shaft, and the moving panel pivots about the shaft to move along one of an outer circumferential surface and an inner circumferential surface of the fixed panel.

### CROSS-REFERENCE TO RELATED APPLICATION

This application is based upon and claims the benefit of priority from Japanese patent application No. 2018-077043, filed on Apr. 12, 2018, the disclosure of which is incorporated herein in its entirety by reference.

### BACKGROUND OF THE INVENTION

### Field of the Invention

The present invention relates to a shaping apparatus and a method of manufacturing the shaping apparatus.

### Description of the Related Art

In the above technical field, patent literature 1 discloses a technique of performing door opening by flipping up an upper door of a three-dimensional shaping apparatus.

[Patent Literature 1] Japanese Patent Laid-Open No. 2013-67016

### SUMMARY OF THE INVENTION

In the technique described in the above literature, however, in a state in which the upper door is open, the overall apparatus is large due to the flipped upper door.

The present invention enables to provide a technique of solving the above-described problem.

One example aspect of the present invention provides a shaping apparatus comprising a shaping unit that forms a shaped object and a case that stores the shaping unit,

the case comprising a fixed panel having a curved surface and a moving panel having a curved surface,

wherein the fixed panel and the moving panel are engaged with each other via a shaft, and

the moving panel pivots about the shaft to move along one of an outer circumferential surface and an inner circumferential surface of the fixed panel.

Another example aspect of the present invention provides a method of manufacturing a shaping apparatus including a shaping unit that forms a shaped object and a case that stores the shaping unit, the method comprising:

arranging the shaping unit to be stored in the case; and

engaging, via a shaft, a fixed panel having a curved surface and a moving panel having a curved surface,

wherein the moving panel pivots about the shaft to move along one of an outer circumferential surface and an inner circumferential surface of the fixed panel.

According to the present invention, the overall apparatus does not become large.

### BRIEF DESCRIPTION OF THE DRAWINGS

FIG. 1 is a view for explaining the arrangement of a shaping apparatus according to the first example embodiment of the present invention;

FIG. 2A is a view for explaining the overall arrangement of a shaping apparatus according to the second example embodiment of the present invention;

FIG. 2B is a schematic sectional view for explaining the arrangement of the shaping apparatus according to the second example embodiment of the present invention;

FIG. 2C is a schematic sectional view for explaining the arrangement of the shaping apparatus according to the second example embodiment of the present invention;

FIG. 2D is a view for explaining another arrangement of a rail provided in the shaping apparatus according to the second example embodiment of the present invention;

FIG. 2E is a view for explaining still other arrangement of the rail provided in the shaping apparatus according to the second example embodiment of the present invention;

FIG. 2F is a perspective view for explaining an example of a shaping unit stored in a case according to the second example embodiment of the present invention;

FIG. 2G is a partial enlarged side view for explaining the example of the shaping unit stored in the case according to the second example embodiment of the present invention;

FIG. 3 is a plan view for explaining opening/closing of the moving panel of the shaping apparatus according to the second example embodiment of the present invention;

FIG. 4A is a view for explaining a state in which a vat is set in the shaping apparatus according to the second example embodiment of the present invention;

FIG. 4B is a schematic view for explaining a state in which the vat is set in the shaping apparatus according to the second example embodiment of the present invention;

FIG. 5 is a view for explaining the overall arrangement of a shaping apparatus according to the third example embodiment of the present invention;

FIG. 6A is a view for explaining the arrangement of a shaping apparatus according to the fourth example embodiment of the present invention;

FIG. 6B is a schematic sectional view for explaining the arrangement of the shaping apparatus according to the fourth example embodiment of the present invention; and

FIG. 7 is a view for explaining the overall arrangement of a shaping apparatus according to the fifth example embodiment of the present invention.

### DESCRIPTION OF THE EXAMPLE EMBODIMENTS

Example embodiments of the present invention will now be described in detail with reference to the drawings. It should be noted that the relative arrangement of the components, the numerical expressions and numerical values set forth in these example embodiments do not limit the scope of the present invention unless it is specifically stated otherwise.

### First Example Embodiment

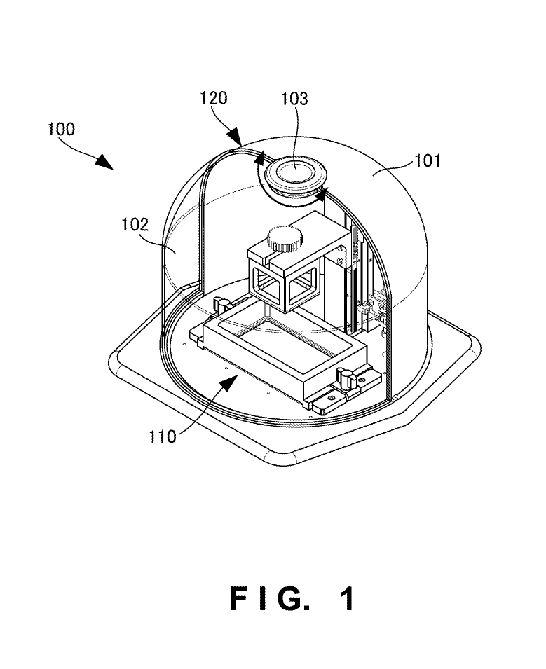

A shaping apparatus 100 according to the first example embodiment of the present invention will be described with reference to FIG. 1. The shaping apparatus 100 is an apparatus that forms a shaped object.

As shown in FIG. 1, the shaping apparatus 100 includes a shaping unit 110 that forms a shaped object, and a case 120 that stores the shaping unit 110. The case 120 includes a fixed panel 101 having a curved surface, and a moving panel 102 having a curved surface. The fixed panel 101 and the moving panel 102 are engaged with each other via a shaft 103. The moving panel 102 pivots about the shaft 103 to move along the outer or inner circumferential surface of the fixed panel 101.

According to this example embodiment, the overall apparatus does not become large.

### Second Example Embodiment

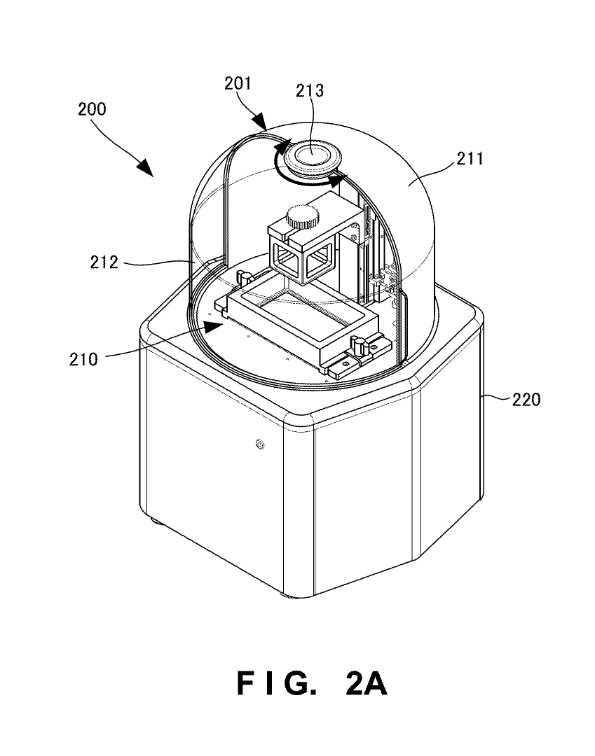

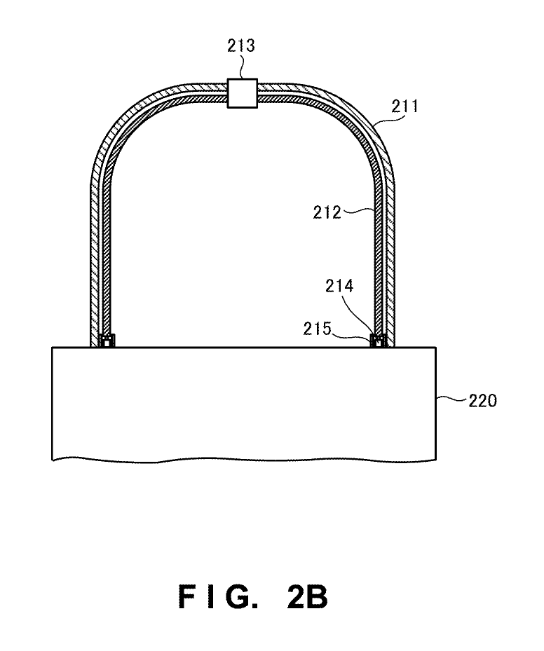

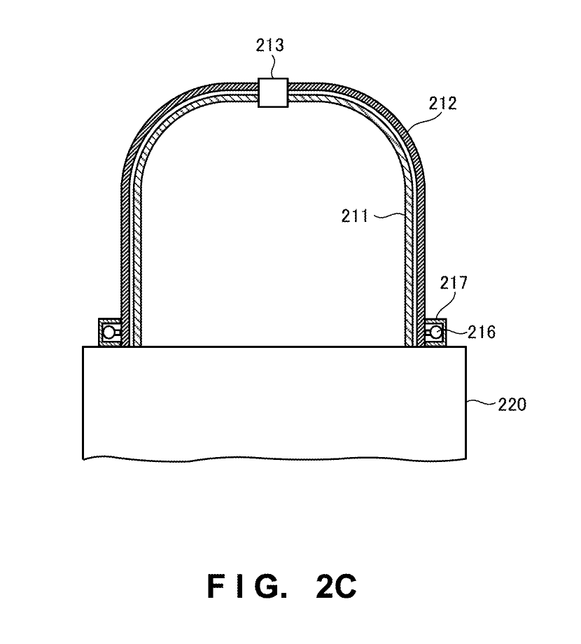

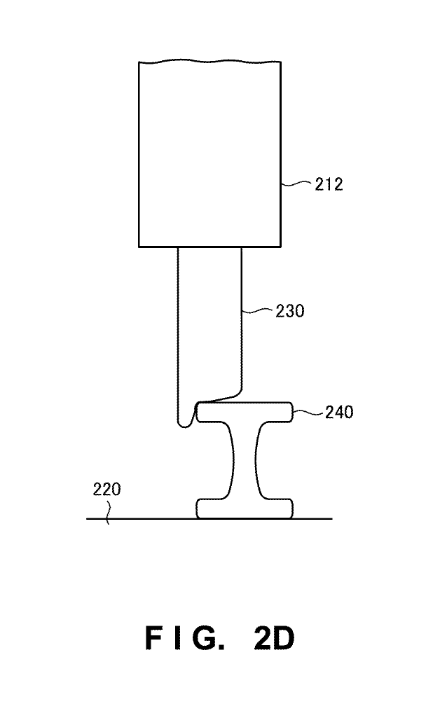

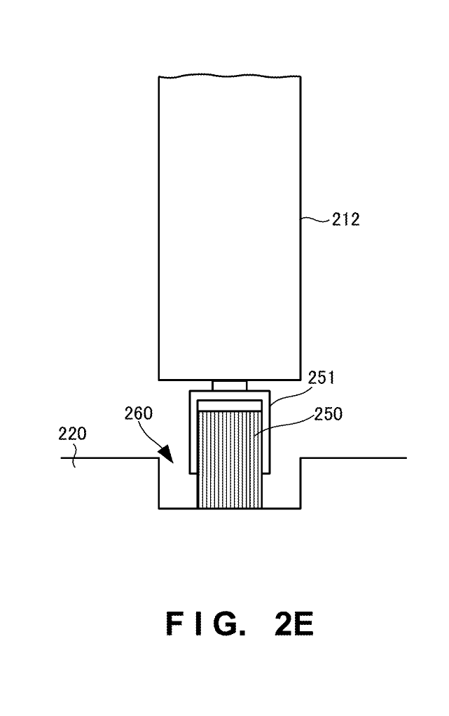

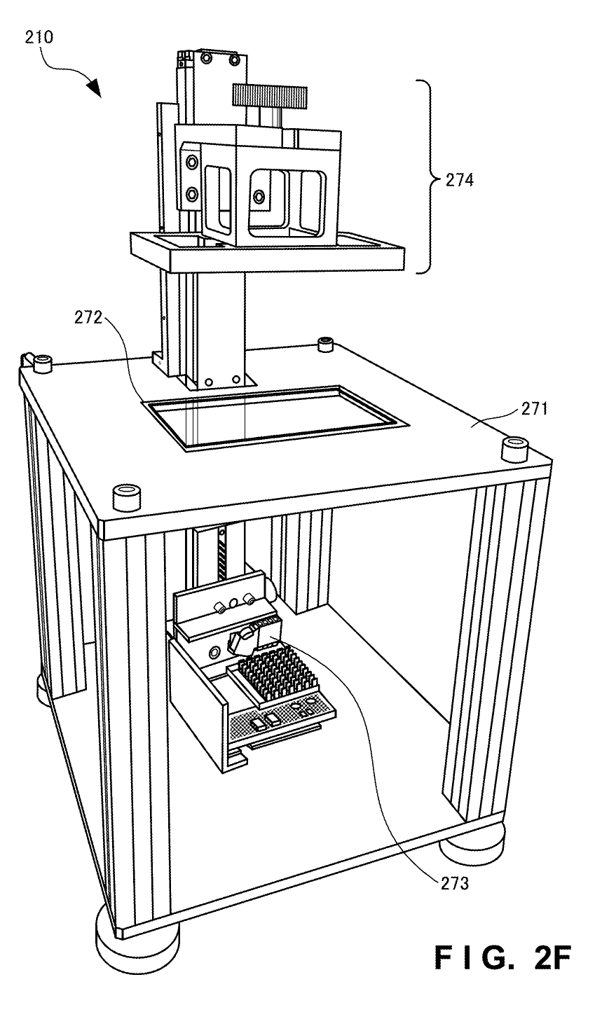

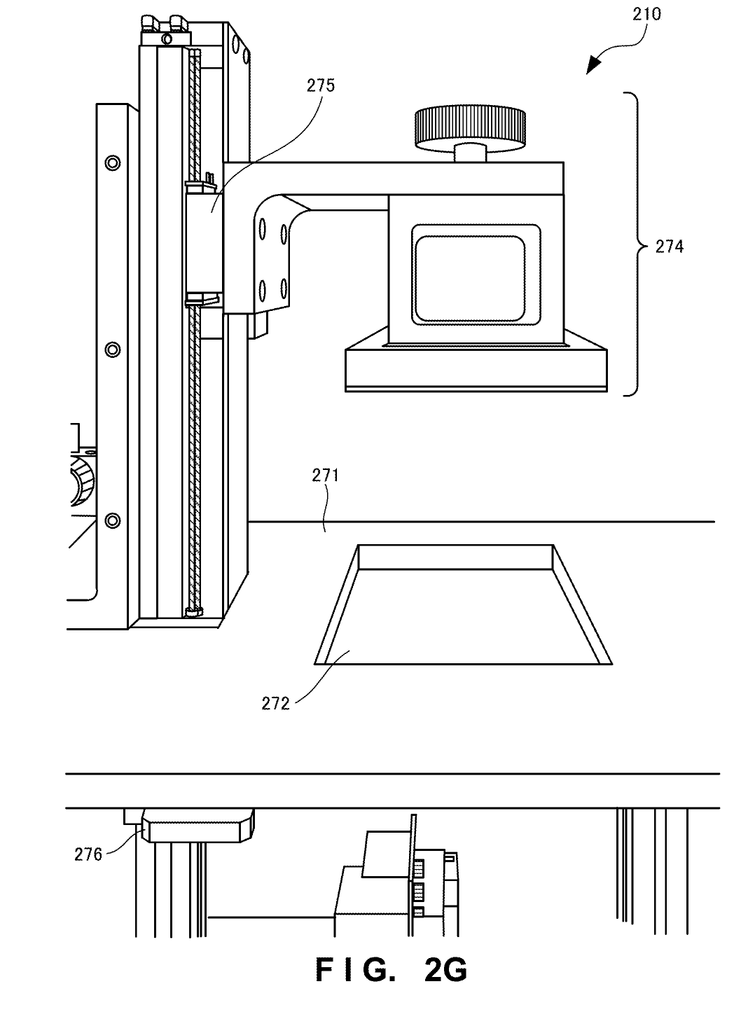

A shaping apparatus according to the second example embodiment of the present invention will be described next with reference to FIGS. 2A to 4B. FIG. 2A is a view for explaining the overall arrangement of the shaping apparatus according to this example embodiment.

A shaping apparatus 200 includes a shaping unit 210 and a case 201 that stores the shaping unit 210. The case 201 includes a fixed panel 211 and a moving panel 212. The shaping unit 210 is a light beam irradiation type shaping mechanism, and is a mechanism that manufactures a shaped object or a circuit pattern by irradiating, with a light beam, the material of the shaped object or a sheet for circuit pattern formation.

The case 201 has a dome shape. The dome-shaped case 201 includes a hemispherical upper portion and a cylindrical (columnar) lower portion. The case 201 has a dome shape formed by connecting the hemispherical portion and the cylindrical portion. The upper portion of the case 201 has a hemispherical shape formed by combining the upper portion of the fixed panel 211 having a quarter-spherical shape and the upper portion of the moving panel 212 having a quarter-spherical shape. Similarly, the lower portion of the case 201 has a cylindrical (columnar) shape formed by combining the semi-cylindrical (semi-columnar) lower portion of the fixed panel 211 and the semi-cylindrical (semi-columnar) lower portion of the moving panel 212. As described above, the fixed panel 211 and the moving panel 212 have the shapes with curved surfaces.

The moving panel 212 is arranged on the front side of the shaping apparatus 200, and the fixed panel 211 is arranged on the rear side (back side) of the shaping apparatus 200. The fixed panel 211 and the moving panel 212 are arranged on a base 220. Note that the base 220 has a hexagonal shape. However, the shape of the base 220 is not limited to this, and may be a circular shape, an elliptic shape, a triangular shape, a rectangular shape, or another polygonal shape.

The fixed panel 211 and the moving panel 212 are engaged with each other via a shaft 213. The shaft 213 serves as a fulcrum for engaging the fixed panel 211 and the moving panel 212. The moving panel 212 pivots about the shaft 213. The shaft 213 is provided in the apex portion of the dome-shaped case 201.

The moving panel 212 pivots about the shaft 213 to move along the inner or outer circumferential surface of the fixed panel 211. The fixed panel 211 and the moving panel 212 are arranged so that the moving panel 212 is located inside the fixed panel 211 (included in the fixed panel 211) in a state in which it rotates (pivots) by 180°.

The fixed panel 211 is an opaque member, and the moving panel 212 is a transparent member. When the moving panel 212 is a transparent member, even while shaping by the shaping unit 210 is performed, the user can see a state in the shaping apparatus 200. Note that the fixed panel 211 may be a transparent member.

Note that the surface of the moving panel 212 may be coated so a light beam of a specific wavelength such as ultraviolet rays from the shaping unit 210 in the shaping apparatus 200 is not transmitted. The moving panel 212 may be manufactured using a material which does not transmit the light beam of the specific wavelength but allows the user to see the interior. Thus, the light beam of the specific wavelength from the interior of the shaping apparatus 200 never adversely influences the eyes of the user. In addition, the user need not wear goggles or the like to protect his/her eyes.

If, for example, the moving panel 212 is made of an opaque material, the light beam from the interior of the shaping apparatus 200 can be shielded completely but the user cannot see the state in the shaping apparatus 200. Furthermore, if the user cannot see the state of the interior of the shaping apparatus 200, for example, even if a trouble occurs during shaping, the user cannot visually confirm the trouble, and thus cannot cope with the trouble quickly.

Note that the shaping apparatus 200 has a size of about 520 mm (height)×about 350 mm (width)×about 350 mm (depth), and the case 201 has a height (dome height) of about 250 mm. However, the sizes of the shaping apparatus 200 are not limited to them.

FIG. 2B is a schematic sectional view for explaining the arrangement of the shaping apparatus according to this example embodiment. The fixed panel 211 is arranged outside the moving panel 212. The moving panel 212 is arranged inside the fixed panel 211. That is, the moving panel 212 is included in the fixed panel 211.

A rail 215 supports the moving panel 212 to be movable. The moving panel 212 includes a roller 214. The rail 215 is provided on the mounting surface (placement surface) of the moving panel 212 of the base 220. The rail 215 is mounted on the placement surface of the base 220 at a position along the periphery of the placement surface. The rail 215 has, as its sectional shape, a C shape facing upward. The roller 214 is arranged between the moving panel 212 and the placement surface of the base 220, and projects downward from the bottom surface of the moving panel 212. Note that the shape of the rail 215 is not limited to that shown in FIG. 2B.

The moving panel 212 pivots about the shaft 213 to move along the rail 215. That is, the shaping apparatus 200 includes the roller 214 and the rail 215 as a pivoting slide mechanism for making the moving panel 212 pivot to move. Since the moving panel 212 is moved by the roller 214 and the rail 215 in this way, the moving panel 212 can be moved smoothly. Note that the roller 214 and the rail 215 may be members made of rubber, plastic, metal, or the like, but they are not limited to them.

FIG. 2C is a schematic sectional view for explaining the arrangement of the shaping apparatus according to this example embodiment. Referring to FIG. 2C, the arrangement of the fixed panel 211 and the moving panel 212 is opposite to that shown in FIG. 2B. That is, the fixed panel 211 is arranged inside the moving panel 212. The moving panel 212 is arranged outside the fixed panel 211. That is, the fixed panel 211 is included in the moving panel 212.

A rail 217 supports the moving panel 212 to be movable. The moving panel 212 includes a roller 216. The rail 217 is provided along the outer circumferential surface of the moving panel 212. The rail 217 has a C shape as its sectional shape. The roller 216 projects outward from the side surface of the moving panel 212. The roller 216 is attached to the moving panel 212 via the support member of the roller 216. Note that the shape of the rail 217 is not limited to that shown in FIG. 2C.

The moving panel 212 pivots about the shaft 213 to move along the rail 217. That is, the shaping apparatus 200 includes the roller 216 and the rail 217 as a pivoting slide mechanism for making the moving panel 212 pivot to move. Since the moving panel 212 is moved by the roller 216 and the rail 217 in this way, the moving panel 212 can be moved smoothly. Note that the roller 216 and the rail 217 may be members made of rubber, plastic, metal, or the like, but they are not limited to them.

FIG. 2D is a view for explaining another arrangement of a rail provided in the shaping apparatus according to this example embodiment. A rail 240 is provided on the placement surface of the base 220. That is, the rail 240 is laid on the base 220. A roller 230 is provided on the bottom surface of the moving panel 212. The roller 230 is, for example, a wheel, and the lower portion of the roller 230 projects downward from the bottom surface of the moving panel 212. Then, the upper portion of the roller 230 is hidden inside the moving panel 212. An axle shaft or the like that supports the roller 230 is provided inside the moving panel 212.

The rail 240 has, as its sectional shape, an H shape facing sideways. The roller 230 contacts the upper surface of the rail 240. The roller 230 travels on the rail 240. The shapes of the roller 230 and the rail 240 are similar to, for example, those of the wheel and rail of an electric train. Note that the roller 230 and the rail 240 may be members made of rubber, plastic, metal, or the like, but they are not limited to them.

FIG. 2E is a view for explaining still other arrangement of a rail provided in the shaping apparatus according to this example embodiment. A groove is cut in the placement surface of the base 220, and serves as a rail 260. The groove is cut along the periphery of the placement surface of the base 220. A roller 250 is provided on the bottom surface of the moving panel 212. The roller 250 projects downward from the bottom surface of the moving panel 212. The roller 250 is, for example, a tire (wheel), and rolls on the rail 260. The width of the rail 260 (the width of the groove) need only be larger than that of the roller 250. The depth of the rail 260 (the depth of the groove) need only be a depth that does not hinder the roller 250 from rolling on the rail 260. Note that the roller 250 is attached to the moving panel 212 via an attachment 251. The attachment 251 is provided with the axle shaft of the roller 250.

FIG. 2F is a perspective view for explaining an example of the shaping unit stored in the case according to this example embodiment. FIG. 2G is a partial enlarged side view for explaining the example of the shaping unit stored in the case according to this example embodiment.

The shaping unit 210 stored in the case 201 includes a shaping base 271, a light beam irradiation window 272, an optical engine 273, a lifting head 274, a head feed mechanism 275, and a stepping motor 276. The size of the shaping unit 210 is, for example, 250 mm (width)×291 mm (depth)×490 mm (height).

A pattern forming sheet or a resin tank (vat) that temporarily stores a resin as the material of a shaped object or the like is placed on the shaping base 271, thereby manufacturing a shaped object (three-dimensional shaped object or three-dimensional laminated shaped object) or a circuit pattern.

The optical engine 273 is a high-power precise engine. Note that a light beam emitted from the optical engine 273 has a wavelength of 405 nm. However, the wavelength is not limited to this and may be 200 nm to 400 nm. The light beam emitted from the optical engine 273 is focus free.

Although a detailed arrangement of the optical engine 273 is not illustrated, the optical engine 273 includes a light source, a reflecting mirror, a photodetector, and a two-dimensional MEMS (Micro Electro Mechanical Systems) mirror. The light source includes a semiconductor LD (Laser Diode) or a collimator lens. The semiconductor LD is a laser oscillation element that oscillates a UV laser beam or the like. Note that the laser oscillation element is not limited to the semiconductor LD, and may be an LED (Light Emitting Diode). The two-dimensional MEMS mirror is a driven mirror driven based on a control signal input from the outside. The two-dimensional MEMS mirror is a device that vibrates to reflect the laser beam while changing the angle in the horizontal direction (X direction) and the vertical direction (Y direction). The optical engine 273 has a resolution of 720 P or 1080 P, and has a width of about 30 mm, a depth of about 15 mm, a height of about 7 mm, and a volume of about 3 cc. One or a plurality of semiconductor LDs may be arranged in the optical engine 273, and a necessary number of optical engines are arranged in accordance with the application purpose. The spot size of the light beam emitted from the optical engine 273 is 75 μm but can be changed in accordance with the application purpose. Note that the mirror system used for the optical engine 273 may be, for example, a galvanometer mirror system or DLP (Digital Light Processing) system, instead of the two-dimensional MEMS mirror system.

The shaping base 271 is provided with the light beam irradiation window 272. The light beam emitted from the optical engine 273 passes through the light beam irradiation window 272 and irradiates the pattern forming sheet or vat placed on the shaping base 271. The light beam irradiation window 272 is an opening portion provided in the shaping base 271 or a hole formed in the shaping base 271.

The lifting head 274 is used to manufacture a shaped object. The lifting head 274 is moved up and down by the head feed mechanism 275 and the stepping motor 276. The head feed mechanism 275 is a high-rigidity ball screw feed mechanism. The stepping motor 276 is a high-torque stepping motor. Note that the structure for moving up and down the lifting head 274 is not limited to the structure using the head feed mechanism 275 and the stepping motor 276. In addition, the head feed mechanism 275 is not limited to the ball screw feed mechanism.

The head feed mechanism 275 is a high-rigidity and high-speed precision feed mechanism. In addition, the feed speed of the head feed mechanism 275 is, for example, 3 kg weigh·50 mm/sec·2.5 μm pitch. In addition, the lifting head 274 is a high-rigidity lightweight head.

The manufacture of the shaped object is performed by causing the optical engine 273 to emit the light beam toward the resin tank (vat) placed on the shaping base 271 and lifting the lifting head 274 in a lifting direction. The lifting speed of the lifting head 274 is appropriately decided based on the wavelength or intensity of the light beam, the type of the material, or the like. Note that the size of the lifting head 274 is, for example, 140 mm×80 mm.

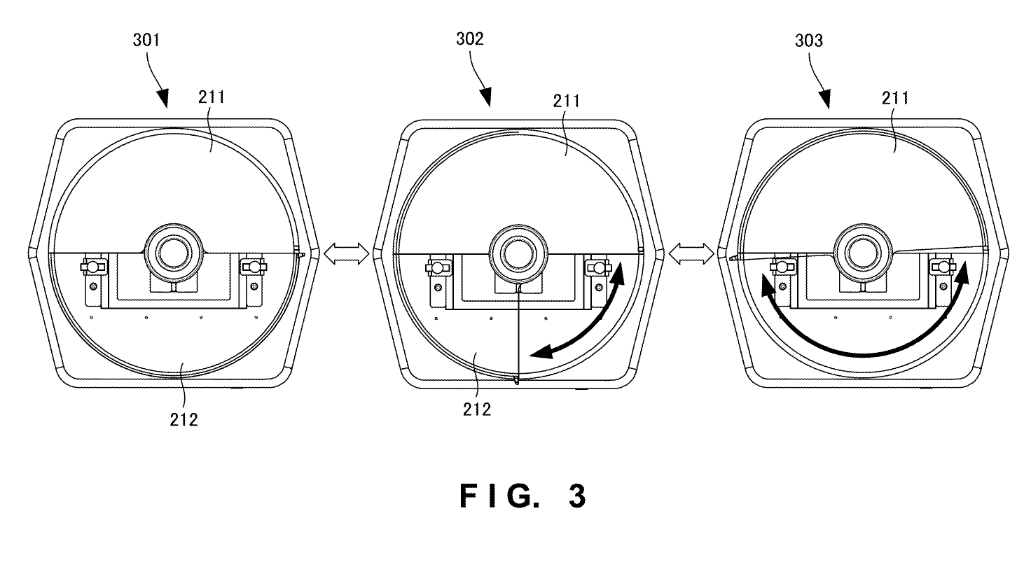

FIG. 3 is a plan view for explaining opening/closing of the moving panel of the shaping apparatus according to this example embodiment. FIG. 3 shows a closed state (301), a half-open state (302), a full-open state (303) of the moving panel 212, that is, a door closed state, a door half-open (half-closed) state, a door open state. In the door open state, the moving panel 212 and the fixed panel 211 are superimposed on each other.

FIG. 3 shows a state in which the moving panel 212 pivots in the counterclockwise direction to slide. The same applies to a case in which the moving panel 212 pivots in the clockwise direction. The moving panel 212 may pivot in both the clockwise and counterclockwise directions, or pivot in one of the clockwise and counterclockwise directions. The moving panel 212 may pivot (rotate) by 180° or 360°. Note that even if the moving panel 212 pivots by 180°, the case 201 is not full-open but half-open (is half opened and is not opened more than in the half-open state).

The moving panel 212 may be opened/closed manually or automatically. For example, there may be provided a driving unit (not shown) that makes the moving panel 212 pivot to move. The driving unit is, for example, a motor or the like. If the driving unit is provided, the moving panel 212 can be made to pivot automatically, and can thus be opened/closed automatically like an automatic door.

If, for example, an infrared sensor is provided in the base 220 or the like, and the user shades the infrared sensor with his/her hand, the moving panel 212 pivots to slide, and the shaping apparatus 200 performs a door opening or closing operation.

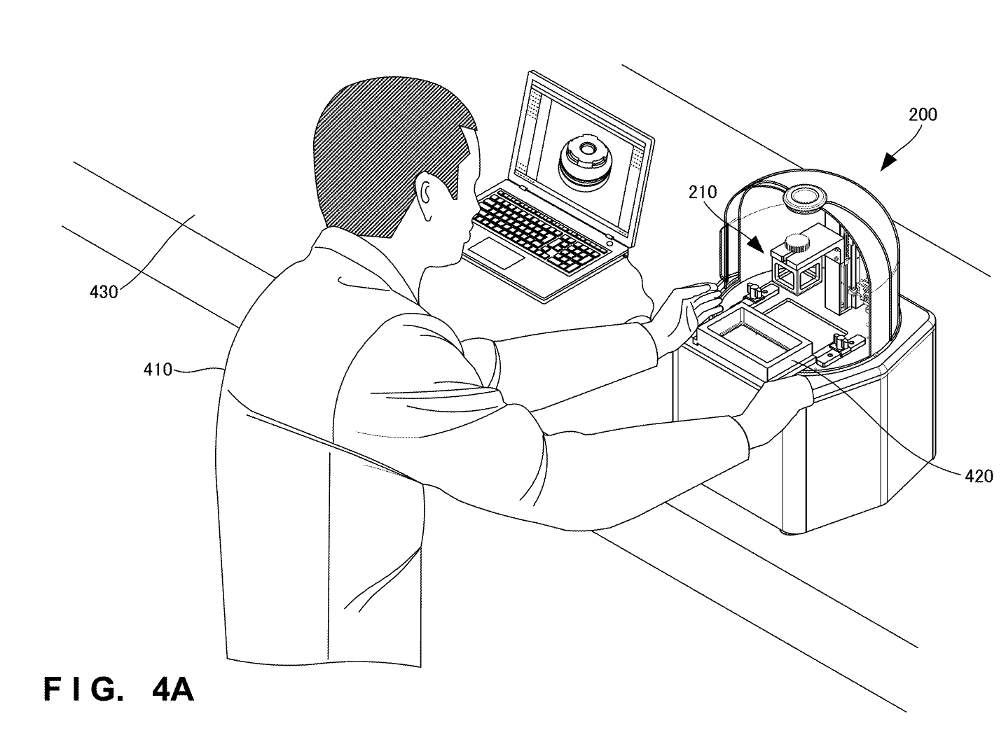

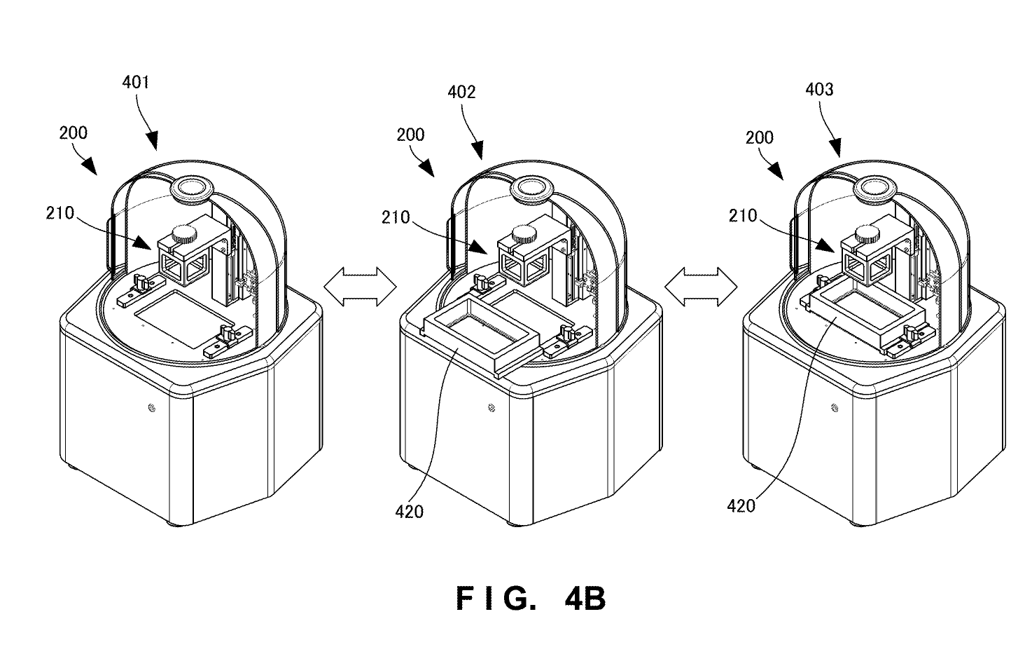

FIG. 4A is a view for explaining a state in which a vat is set in the shaping apparatus according to this example embodiment. A user 410 sets a resin tank 420 (vat) in the shaping apparatus 200 placed on a workbench 430 while the moving panel 212 of the shaping apparatus 200 is set in the door open state. Since the resin tank 420 (vat) is a shallow box-shaped container made of a transparent material, the remaining amount of a resin put in the resin tank 420 can easily be confirmed. The size of the resin tank 420 is, for example, 195 mm×185 mm×45 mm.

FIG. 4B is a schematic view for explaining a state in which the vat is set in the shaping apparatus according to this example embodiment. As shown in FIG. 4B, the user 410 sets the shaping apparatus 200 in the door open state from a state (401) in which the resin tank 420 is not set, and moves the resin tank 420 closer to the shaping unit 210 from the front side of the shaping apparatus 200 (402). The user 410 moves the resin tank 420 closer to the shaping unit 210, places the resin tank 420 on the shaping base 271, and sets the resin tank 420 in the shaping unit 210 (403).

As shown in FIG. 4B, since the front portion of the shaping apparatus 200 is opened by 180°, it is possible to ensure a space enough for the user 410 to perform a work. Therefore, the user 410 readily performs a work, thereby improving the work efficiency.

According to this example embodiment, since the moving panel pivots about the shaft to slide, the size or dimensions of the shaping apparatus remain unchanged even in the door open state. Therefore, even if the shaping apparatus is set in the door open state, the overall shaping apparatus does not become large. If opening/closing of the moving panel (door) is automated using a sensor, the moving panel can be opened/closed without touching the door, thereby making it possible to prevent pollution or contamination. Since the moving panel is transparent, the user can see the state of the interior to confirm the progress of shaping. Since a simple opening/closing mechanism that slides the moving panel is adopted, few failures occur, and the labor for maintenance is small. If lightproof transparent glass (polarizing glass) is used for the moving panel, even if the user looks at light for a long time, the influence on the eyes of the user can be reduced. Since the shaping unit is stored in the shaping apparatus, the shaping unit can be protected. Furthermore, since the shaping unit is stored in the case, it is possible to prevent the resin or the like as the material of a shaped object from scattering outside. Furthermore, if the door is closed while the shaping unit shapes a shaped object, dust from the interior never scatters outside, dust from the outside is never mixed in the shaped object, or dust never adheres to the shaped object.

### Third Example Embodiment

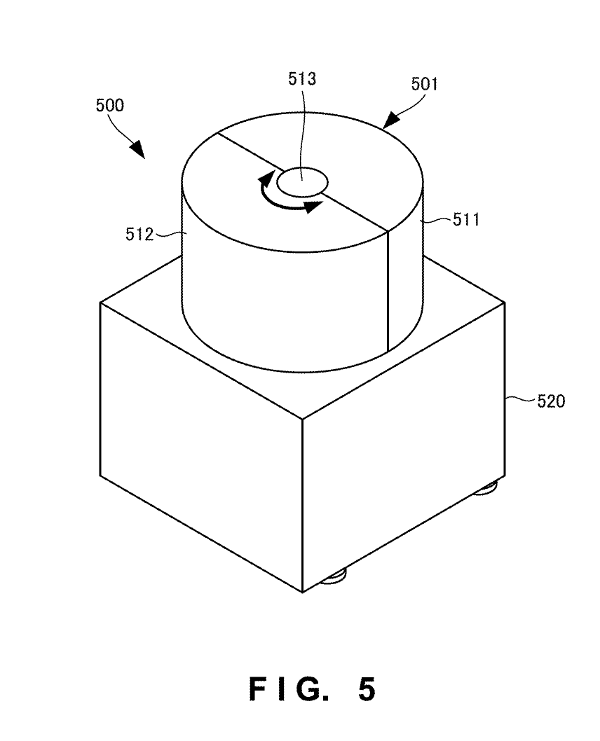

A shaping apparatus according to the third example embodiment of the present invention will be described next with reference to FIG. 5. FIG. 5 is a view for explaining the overall arrangement of the shaping apparatus according to this example embodiment. The shaping apparatus according to this example embodiment is different from the second example embodiment in that a cover portion has a columnar shape. The remaining components and operations are the same as those in the second example embodiment. Hence, the same reference numerals denote the same components and operations, and a detailed description thereof will be omitted.

A shaping apparatus 500 includes a columnar (cylindrical) cover portion 501. The cover portion 501 includes a fixed panel 511 and a moving panel 512. Each of the fixed panel 511 and the moving panel 512 has a shape obtained by vertically cutting a column (cylinder) into two parts. That is, each of the fixed panel 511 and the moving panel 512 has a shape obtained by cutting a column by a plane passing through a central axis, that is, a semi-columnar shape.

The cover portion 501 is formed by combining the semi-columnar fixed panel 511 and the semi-columnar moving panel 512. The fixed panel 511 and the moving panel 512 are engaged with each other via a shaft 513. The shaft 513 is on the central axis of the columnar cover portion 501. The cover portion 501 is mounted on a base 520. The base 520 has a rectangular shape but the shape of the base 520 is not limited to this.

The moving panel 512 pivots about the shaft 513 to move along the inner or outer circumferential surface of the fixed panel 511. That is, the moving panel 512 pivots about the shaft 513 to slide.

According to this example embodiment, since the height of the cover portion is lower than that of the dome-shaped cover portion, the height of the shaping apparatus becomes lower, and the size of the shaping apparatus can be further reduced.

### Fourth Example Embodiment

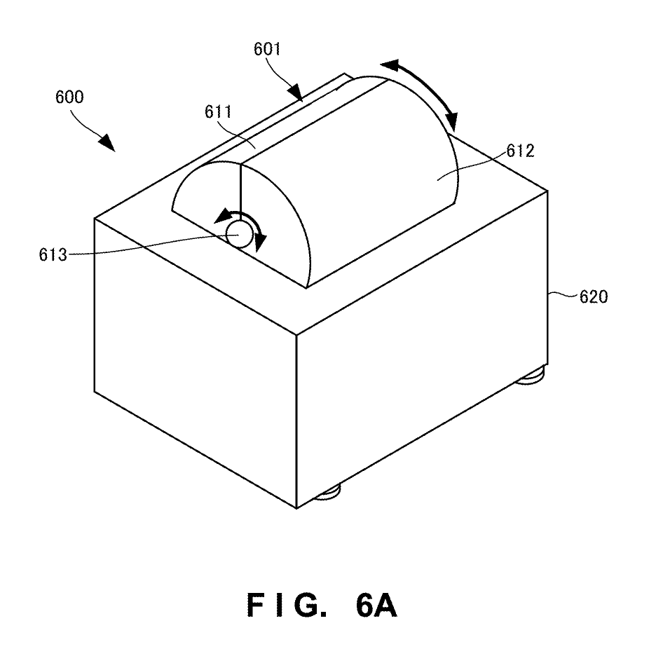

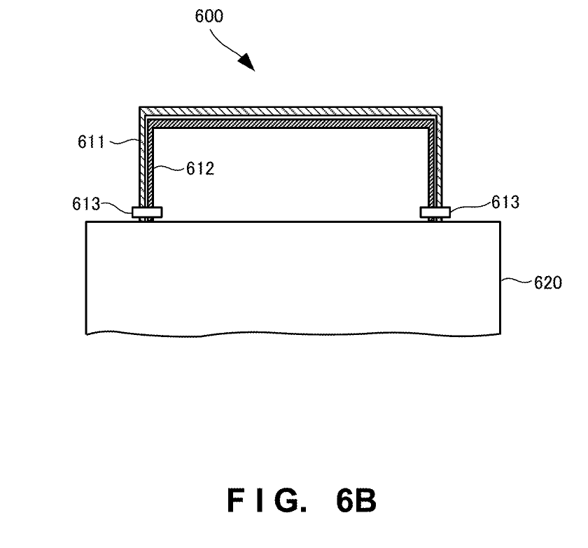

A shaping apparatus according to the fourth example embodiment of the present invention will be described next with reference to FIGS. 6A and 6B. FIG. 6A is a view for explaining the overall arrangement of the shaping apparatus according to this example embodiment. The shaping apparatus according to this example embodiment is different from the above-described second and third example embodiments in that a cover portion has a semi-columnar shape. The remaining components and operations are the same as those in the second and third example embodiments. Hence, the same reference numerals denote the same components and operations, and a detailed description thereof will be omitted.

A shaping apparatus 600 includes a semi-columnar cover portion 601. The cover portion 601 includes a fixed panel 611 and a moving panel 612. Each of the fixed panel 611 and the moving panel 612 has a shape obtained by vertically cutting a column into four parts. That is, each of the fixed panel 611 and the moving panel 612 has a quarter-columnar shape obtained by cutting, into two part, a semi-column obtained by cutting a column by a plane passing through a central axis. The cover portion 601 has a shape obtained by laying down a semi-column (semi-cylindrical shape).

The cover portion 601 is formed by combining the quarter-columnar fixed panel 611 and the quarter-columnar moving panel 612. The fixed panel 611 and the moving panel 612 are engaged with each other via a shaft 613. Note that the fixed panel 611 and the moving panel 612 are also engaged with each other via another shaft on the opposite side of the shaft 613. That is, the fixed panel 611 and the moving panel 612 are engaged with each other via the two shafts. The shaft 613 is located at a position on the central axis of the column. The cover portion 601 is mounted on a base 620. In this example, the base 620 has a rectangular shape but the shape of the base 620 is not limited to this.

The moving panel 612 pivots about the shaft 613 (and the other shaft) to move along the inner or outer circumferential surface of the fixed panel 611. That is, the moving panel 612 pivots about the shaft 613 to slide.

FIG. 6B is a schematic sectional view for explaining the arrangement of the shaping apparatus according to this example embodiment. In a state in which the moving panel 612 slides to set the cover portion 601 in the door open state, the fixed panel 611 includes the moving panel 612. That is, the moving panel 612 slides inside the fixed panel 611 along the inner circumferential surface of the fixed panel 611. Note that the positional relationship between the fixed panel 611 and the moving panel 612 may be inverted so that the moving panel 612 slides outside the fixed panel 611. The fixed panel 611 and the moving panel 612 are engaged with each other via the two shafts 613. Note that the positional relationship between the fixed panel 611 and the moving panel 612 may be inverted.

According to this example embodiment, since the cover portion has a semi-columnar shape, the height of the shaping apparatus becomes lower and the size of the shaping apparatus can be further reduced.

### Fifth Example Embodiment

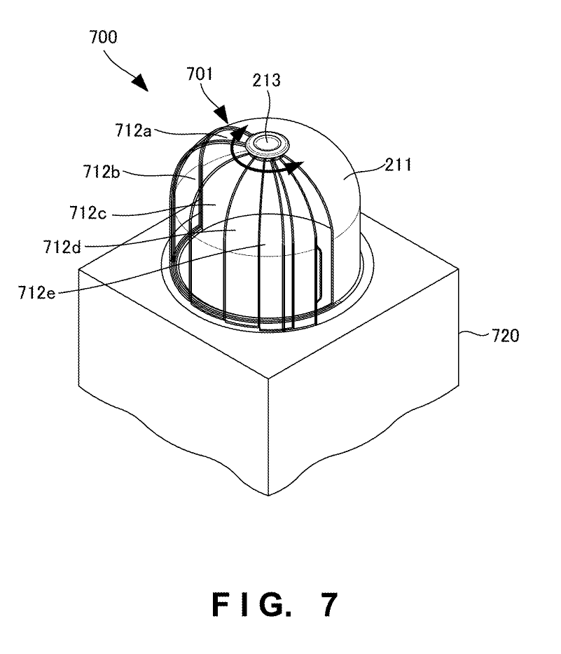

A shaping apparatus according to the fifth example embodiment of the present invention will be described with reference to FIG. 7. FIG. 7 is a view for explaining the overall arrangement of the shaping apparatus according to this example embodiment. The shaping apparatus according to this example embodiment is different from the above-described second to fourth example embodiments in that a plurality of moving panels are included. The remaining components and operations are the same as those in the second to fourth example embodiments. Hence, the same reference numerals denote the same components and operations, and a detailed description thereof will be omitted.

A cover portion 701 of a shaping apparatus 700 includes moving panels 712a to 712e. That is, the shaping apparatus 700 includes the plurality of moving panels 712a to 712e. Note that the number of moving panels 712a to 712e of the shaping apparatus 700 is not limited to five, and may be two or three, or six or more. In the door open state, the moving panels 712a to 712e may be arranged to overlap each other or arranged without overlapping each other.

When opening the moving panels 712a to 712e, the moving panel 712a pivots about a shaft 213 to move, and is stored inside (or outside) the moving panel 712b. Next, a set of the moving panels 712a and 712b pivots about the shaft to move, and is stored inside (or outside) the moving panel 712c. By repeating this operation, the moving panels 712a to 712e are finally stored inside (or outside) a fixed panel 211 to set the door of the shaping apparatus 700 in an open state. When closing the door of the shaping apparatus 700, an operation opposite to the above-described one can close the door. As described above, the moving panels 712a to 712e are configured like shutter blades. Note that the shape of the cover portion 701 may be that described in the third or fourth example embodiment.

According to this example embodiment, if the cover portion (moving panel) is damaged, not all the moving panels but the damaged moving panel among the plurality of moving panels is replaced. Therefore, maintenance is easy and the maintenance cost can be suppressed low.

### Other Example Embodiments

While the invention has been particularly shown and described with reference to example embodiments thereof, the invention is not limited to these example embodiments. It will be understood by those of ordinary skill in the art that various changes in form and details may be made therein without departing from the spirit and scope of the present invention as defined by the claims.

What is claimed is:

1. A shaping apparatus comprising a shaping unit that forms a shaped object and a case that stores said shaping unit,
said case comprising a fixed panel having a curved surface and a moving panel having a curved surface,
wherein said fixed panel and said moving panel are engaged with each other via a shaft, and
said moving panel pivots about the shaft to move along one of an outer circumferential surface and an inner circumferential surface of said fixed panel.

2. The apparatus according to claim 1, further comprising a rail that su pports said moving panel to be movable.

3. The apparatus according to claim 1, wherein said case comprises a plurality of moving panels.

4. The apparatus according to claim 1, wherein said fixed panel and said moving panel have, as a whole, one of a hemispherical shape, a dome shape, and a columnar shape.

5. The apparatus according to claim 1, wherein each of said moving panel and said fixed panel includes at least one of a quarter-spherical shape, semi-columnar shape, and a quarter-columnar shape.

6. The apparatus according to claim 1, further comprising a driving unit that makes said moving panel pivot.

7. The apparatus according to claim 1, wherein said moving panel is transparent.

8. A method of manufacturing a shaping apparatus including a shaping unit that forms a shaped object and a case that stores the shaping unit, the method comprising:
arranging the shaping unit to be stored in the case; and
engaging, via a shaft, a fixed panel having a curved surface and a moving panel having a curved surface,
wherein the moving panel pivots about the shaft to move along one of an outer circumferential surface and an inner circumferential surface of the fixed panel.
